(19) United States
(12) Patent Application Publication
(10) Pub. No.: US 2012/0122001 A1
(43) Pub. Date: May 17, 2012

(54) METHOD FOR DETERMINING AMOUNT OF REACTANT GASES SUPPLIED TO FUEL CELL SYSTEM

(75) Inventor: Nam Woo Lee, Hwaseong (KR)

(73) Assignee: HYUNDAI MOTOR COMPANY, Seoul (KR)

(21) Appl. No.: 13/153,780

(22) Filed: Jun. 6, 2011

(30) Foreign Application Priority Data
Nov. 14, 2010 (KR) 10-2010-0113062

(51) Int. Cl. H01M 8/04

(52) U.S. Cl. 429/431

(57) ABSTRACT

The present invention provides an improved method for determining the amount of reactant gases supplied to a fuel cell system to ensure a stable supply of reactant gases to a fuel cell stack. In particularly, the present invention estimates an output current value of a fuel cell stack by detecting the state of charge of an electricity storage device connected in parallel to the fuel cell stack; measures a target current value according to the amount of output required by a driver; determines the amount of reactant gases to be supplied by comparing the estimated output current value and the target current value; and supplies the determined amount of reactant gases to the fuel cell stack.

### CROSS-REFERENCE TO RELATED APPLICATION

This application claims under 35 U.S.C. §119(a) the benefit of Korean Patent Application No. 10-2010-0113062 filed Nov. 14, 2010, the entire contents of which are incorporated herein by reference.

### BACKGROUND

(a) Technical Field

The present invention relates to a method for determining the amount of reactant gases supplied to a fuel cell system. More particularly, it relates to an improved method for determining the amount of reactant gases supplied to a fuel cell system, which can ensure a stable supply of reactant gases to a fuel cell stack.

(b) Background Art

A fuel cell is a device that produces heat and electrical energy as reaction products by converting chemical energy directly into electrical energy by oxidation and reduction reactions of reactant gases (e.g., hydrogen and oxygen-containing air) continuously supplied to a fuel cell stack. Thus, a vehicle equipped with the fuel cell stack is called a fuel cell vehicle.

The fuel cell stack consists of a plurality of unit cells stacked together. Therefore, when the reactant gases are supplied to each unit cell through an inlet manifold of the fuel cell stack, an oxidation reaction of hydrogen occurs at an anode, and thus hydrogen ions (protons, H⁺) and electrons (e) are produced as a result. The hydrogen ions and electrons are transmitted to a cathode through an electrolyte membrane and a separator, respectively. At the cathode, water is produced by an electrochemical reaction between the hydrogen ions and electrons transmitted from the anode and the oxygen-containing air. Electrical energy generated by the flow of the electrons is supplied to a load requiring the electrical energy through an end plate's current collector.

Generally, when the reactant gases are supplied to the fuel cell stack, the amount of reactant gases supplied is controlled to prevent non-uniformity in the amount of reactant gases supplied to each unit cell and ensure uniform distribution of current generated by each unit cell of the fuel cell stack.

A conventional method for determining the amount of reactant gases supplied to a fuel cell system will be described with reference to FIG. 4 below.

First, a system for determining the amount of reactant gases to be supplied will be described. A gas supply unit 12 is connected to an inlet of a fuel cell stack 10, and a load 14 requiring electricity is connected to an outlet (e.g., a current collector) of the fuel cell stack 10. Further, an electricity storage device 16 for storing electricity is connected to the outlet of the fuel cell stack 10 to charge and discharge the electricity generated by the fuel cell stack 10.

Moreover, a gas supply amount control unit 18 for controlling the amount of reactant gases to be supplied and a gas supply control unit 20 for controlling the gas supply amount control unit 18 are sequentially connected to the gas supply unit 12.

The system for determining the amount of reactant gases to be supplied further includes an actual electrical energy amount measurement unit 22 for detecting the amount of electrical energy generated by the fuel cell stack 10, i.e., an actual output current value of the fuel cell stack 10, and transmitting the detected actual output current value data to the gas supply control unit 20. The system also includes a target electrical energy amount measurement unit 24 for measuring the amount of electrical energy required by the load 14, i.e., a target current value according to the amount of output required a driver, and transmitting the measured target current value data to the gas supply control unit 20.

Accordingly, the target electrical energy amount measurement unit 24 measures the target current value based on the amount of output required by the driver obtained from an accelerator pedal, i.e., based on the amount of electrical energy required by the load 14, and transmits the measured target current value data to the gas supply control unit 20.

At the same time, the actual electrical energy amount measurement unit 22 detects the amount of actual electrical energy generated by the fuel cell stack 10, i.e., the actual output current value, and transmits the detected actual output current value data to the gas supply control unit 20.

Subsequently, the gas supply control unit 20 compares the target current value data transmitted from the target electrical energy amount measurement unit 24 and the actual output current value data transmitted from the actual electrical energy amount measurement unit 22 and determines the amount of reactant gases to be supplied based on a larger value.

Then, when the gas supply amount control unit 18 is controlled to supply the amount of reactant gases, determined by the gas supply control unit 20, to the fuel cell stack 10, the determined amount of reactant gases is then supplied from the gas supply unit 12 to the inlet of the fuel cell stack 10.

However, the above-described conventional method for determining the amount of reactant gases supplied to the fuel cell system has the following issues and difficulties. First, a separate current sensor for detecting the amount of actual electrical energy generated by the fuel cell stack, i.e., the actual output current value of the fuel cell stack, is required. Current sensors are costly and can cause failures in the overall system if they are not working properly. Moreover, the amount of reactant gases to be supplied is determined based on the target output value required by the load, not on the amount of power consumed by the load, which complicates the calculation significantly.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention relates to a method for determining the amount of reactant gases supplied to a fuel cell system. More particularly, the present invention estimates an output current value, actually output from a fuel cell stack, using the state of charge (SOC) of an electricity storage device connected in parallel to the fuel cell stack, instead of using a separate current sensor. Additionally, the present invention determines the amount of reactant gases to be supplied based on the estimated output current value and a target current value according to the amount of output required by a driver.

Moreover, the present invention provides a method for determining the amount of reactant gases supplied to a fuel cell system by calculating an output current value of a fuel cell stack using a current value and the amount of current actually consumed by a load. This current value is the value obtained by detecting the state of charge (SOC) of an electricity storage device, e.g., a battery, connected in parallel to the fuel cell stack, and the amount of current, actually consumed by a load. Subsequently, the present invention also determines the amount of reactant gases to be supplied based on the calculated output current value and a target current value according to the amount of output required by a driver.

In one aspect, the present invention provides a method for determining the amount of reactant gases supplied to a fuel cell system. More specifically, the method estimates an output current value of a fuel cell stack by detecting, by a sensor, the state of charge of an electricity storage device connected in parallel to the fuel cell stack. Then a target current value is measured according to the amount of output required by a driver and the amount of reactant gases to be supplied are determined by comparing the estimated output current value and the target current value. The determined amount of reactant gases is then supplied to the fuel cell stack.

In one embodiment of the present invention, the estimation of the output current value of the fuel cell stack measures the current voltage of the electricity storage device; and estimates the output current value of the fuel cell stack by substituting the measured voltage value into a fuel cell voltage-current map.

In another embodiment, the estimation of the output current value of the fuel cell stack measures the current voltage of the electricity storage device, and estimates the output current value of the fuel cell stack by correcting the measured voltage of the electricity storage device and substituting the corrected voltage into I-V curve data.

In still another embodiment, the estimation of the output current value of the fuel cell stack subtracts the current value of the electricity storage device and the amount of current consumed by balance of plant components, e.g., a motor from a current value of an inverter for motor drive.

In yet another embodiment, the amount of current consumed by the balance of plant components is calculated using a map.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is schematic diagram showing the configuration of a system for a method for determining the amount of reactant gases supplied to a fuel cell system in accordance with an exemplary embodiment of the present invention;

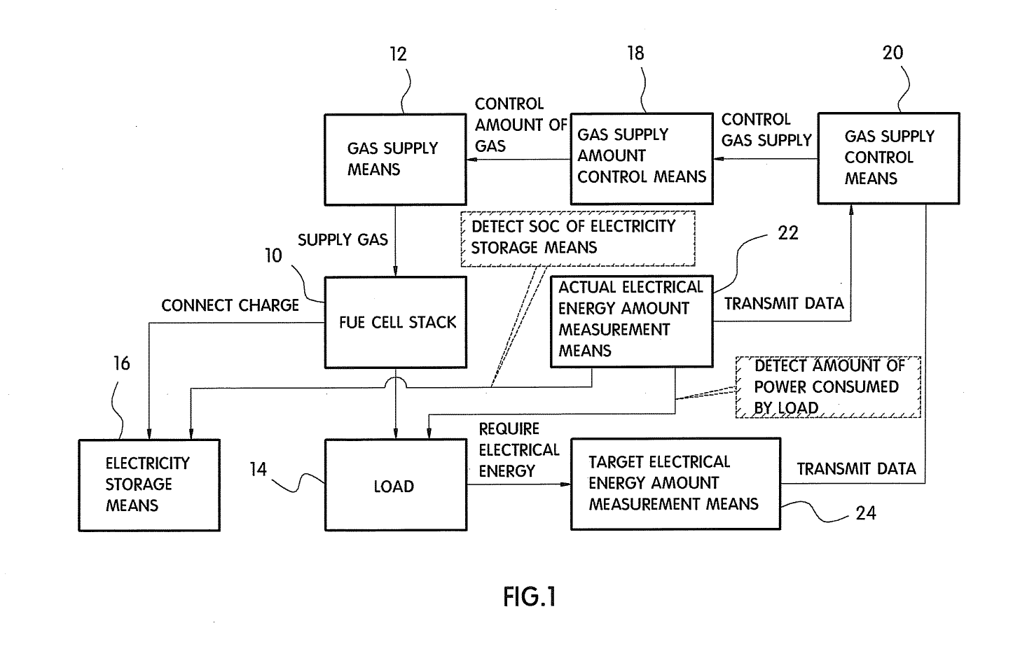

FIG. 2 is a schematic diagram showing a process of estimating an output current value of a fuel cell stack for a method for determining the amount of reactant gases supplied to a fuel cell system in accordance with a preferred embodiment of the present invention;

FIG. 3 is a schematic diagram showing a process of estimating an output current value of a fuel cell stack for a method for determining the amount of reactant gases supplied to a fuel cell system in accordance with another exemplary embodiment of the present invention; and

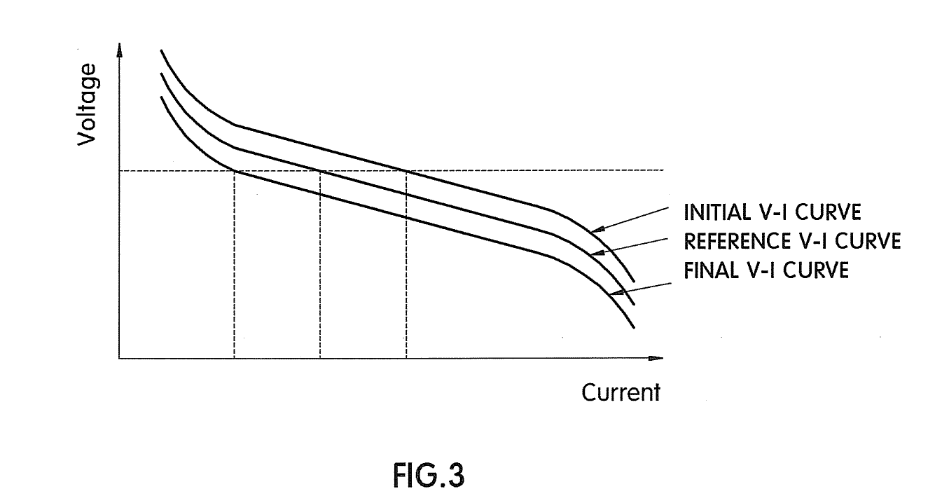

FIG. 4 is a schematic diagram showing a conventional method for determining the amount of reactant gases supplied to a fuel cell system.

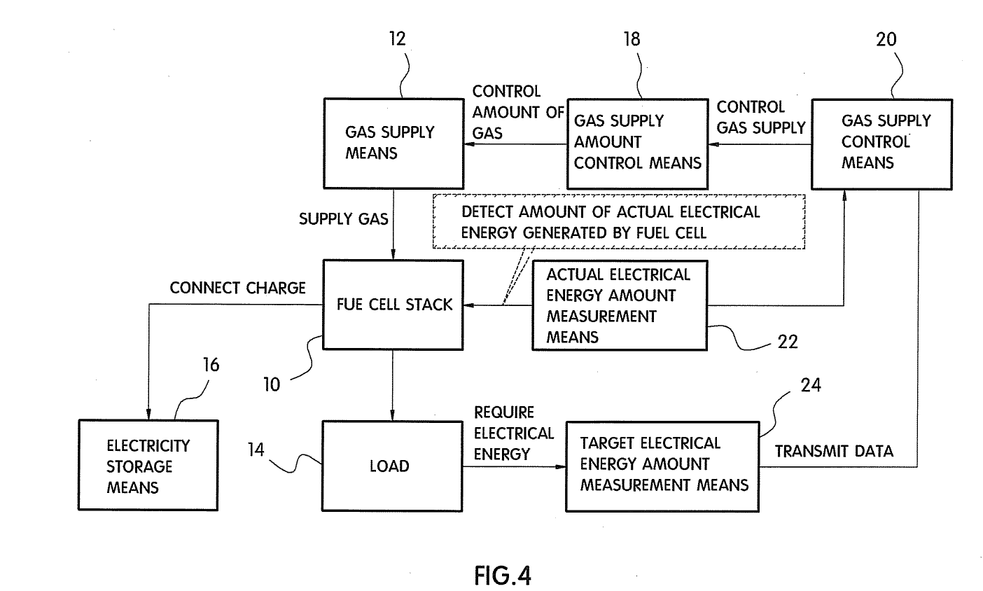

Reference numerals set forth in the Drawings includes reference to the following elements as further discussed below:
10: fuel cell stack
12: gas supply unit
14: load
6: electricity storage device
18: gas supply amount control unit
20: gas supply control unit
22: actual electrical energy amount measurement unit
24: target electrical energy amount measurement unit

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

A system for a method for determining the amount of reactant gases supplied to a fuel cell system in accordance with an exemplary embodiment of the present invention may include a gas supply unit 12 connected to an inlet of a fuel cell stack 10, a load 14 connected to an outlet (e.g., a current collector) of the fuel cell stack 10 and to consume electrical energy, and an electricity storage device 16 for charging or discharging electricity generated by the fuel cell stack 10.

Moreover, a gas supply amount control unit 18 for controlling the amount of reactant gases to be supplied and a gas supply control unit 20 for controlling the gas supply amount control unit 18 are sequentially connected to the gas supply unit 12.

In particular, the system for determining the amount of reactant gases to be supplied in accordance with the present invention further includes an actual electrical energy amount measurement unit 22 for detecting an actual output current value of the fuel cell stack 10 and transmitting the detected actual output current value data to the gas supply control unit 20. The actual electrical energy amount measurement unit 22 is connected in parallel to the electricity storage device 16, e.g., a battery, to detect the state of charge of the electricity storage device 16 and to measure the amount of current actually consumed by the load 14.

The system for determining the amount of reactant gases to be supplied in accordance with the present invention may utilize a target electrical energy amount measurement unit 24 for measuring the amount of electrical energy required by the load 14, e.g., a target current value according to the amount of output required a driver, and transmitting the measured target current value data to the gas supply control unit 20.

Next, a method for determining the amount of reactant gases to be supplied in accordance with in accordance with an embodiment of the present invention, which is performed based on the above-described system for determining the amount of reactant gases to be supplied, will be described.

First, the actual electrical energy amount measurement unit 22 estimates an output current value from the fuel cell stack 10, using the state of charge of the electricity storage device 16 connected in parallel to the fuel cell stack 10.

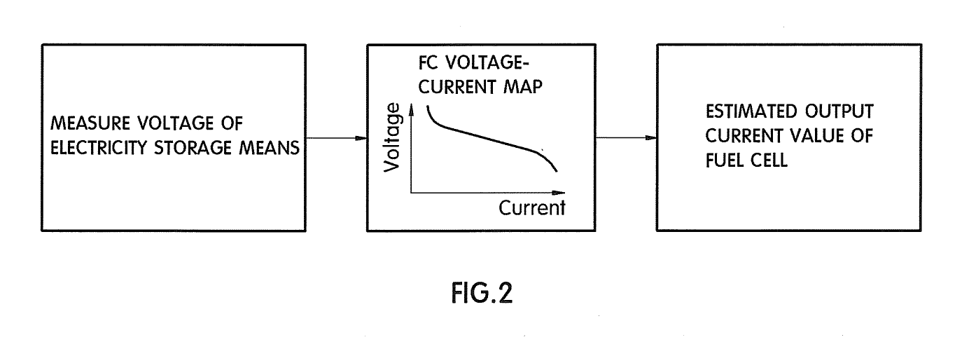

In detail, the output current value is the amount of current actually output from the fuel cell stack 10. This output current value is estimated in the following manner. As shown in FIG. 2, the output current value is calculated using the state of charge (including the voltage and current) of the electricity storage device 16 connected in parallel to the fuel cell stack 10, and this calculated value is estimated as the output current value of the fuel cell stack.

That is, the current voltage of the electricity storage device 16 is measured, and the measured current voltage value is substituted into a fuel cell voltage-current map prestored in the actual electrical energy amount measurement unit 22 to estimate the output current value of the fuel cell stack 10. Then the estimated output current value data is transmitted to the gas supply control unit 20.

Often the measured voltage value of the electricity storage device 16 is only slightly different from the voltage of the fuel cell stack 10. In this event, the voltage of the electricity storage device 16 may be corrected and then substituted into I-V curve data prestored in the actual electrical energy amount measurement unit 22 to estimate the output current value of the fuel cell stack 10, and the estimated output current value data may be transmitted to the gas supply control unit 20.

In parallel, the target electrical energy amount measurement unit 24 measures a target current value based on the amount of output required by a driver obtained from an accelerator pedal, e.g., based on the amount of electrical energy required by the load 14, and transmits the measured target current value data to the gas supply control unit 20.

Then, the gas supply control unit 20 compares the target current value data transmitted from the target electrical energy amount measurement unit 24 and the output current value data transmitted from the actual electrical energy amount measurement unit 22, e.g., the estimated output current value of the fuel cell stack 10, and determines the amount of reactant gases to be supplied based on the larger value of the two values, respectively.

Subsequently, when the gas supply amount control unit 18 is controlled to supply the amount of reactant gases, determined by the gas supply control unit 20, to the fuel cell stack 10, the determined amount of reactant gases is supplied from the gas supply unit 12 to the inlet of the fuel cell stack 10.

As such, according to the above described embodiment of the present invention, it is possible to determine the amount of reactant gases to be supplied by estimating the output current value of the fuel cell stack based on the voltage of the electricity storage device, without the need to directly measure the output current of the fuel cell stack using a separate current sensor.

Next, a method for determining the amount of reactant gases to be supplied in accordance with another embodiment of the present invention, which is performed based on the above-described system for determining the amount of reactant gases to be supplied, will be described.

In this method for determining the amount of reactant gases to be supplied in accordance with another preferred embodiment of the present, the output current value of the fuel cell stack may be estimated in view of the fact that the state of charge of the electricity storage device may differ from the actual output current value of the fuel cell stack by the influence of balance of plant components such as a motor.

Moreover, in the method for determining the amount of reactant gases to be supplied in accordance with another embodiment of the present invention, the actual output current value of the fuel cell stack may be estimated by simultaneously using the state of charge of the electricity storage device and the amount of power consumed by a load.

First, the actual electrical energy amount measurement unit 22 measures the current value of the electricity storage device 16 connected in parallel to the fuel cell stack 10.

At the same time, the actual electrical energy amount measurement unit 22 estimates the current output current value of the fuel cell stack 10 based on the current value of the electricity storage device 16, the current value of an inverter for supplying a current to a motor for driving a fuel cell vehicle, and the amount of current consumed by the balance of plant components (e.g., a motor, an air blower for supplying air to the fuel cell stack, etc.), and transmits the estimated output current value data to the gas supply control unit 20.

In this embodiment, the estimation of the current output current value of the fuel cell stack by the actual electrical energy amount measurement unit 22 may be performed based on the following formula 1:

I_{FC}_{_{—}}_{actual}=Iᵢₙᵥₑᵣₜₑᵣ−I_{ElectricStorageMeans}−I_{Bop} [Formula 1]

In Formula 1, I_{FC}_{_{—}}_{actual} represents the estimated output voltage value of the fuel cell stack, Iᵢₙᵥₑᵣₜₑᵣ represents the amount of current consumed by the inverter, I_{ElectricStorageMeans} represents the current value of the electric storage device, and I_{Bop} represents the amount of current consumed by the balance of plant (BOP) components

As shown in Formula 1, the current output current value of the fuel cell stack can be estimated by subtracting the current value of the electricity storage device and the amount of current consumed by the BOP components from the current value of the inverter for motor drive, which is the amount of current consumed by the BOP components being calculated using a map (for example, in the case of the air blower, a current calculation map with respect to RPM is used.)

Meanwhile, the target electrical energy amount measurement unit 24 measures a target current value based on the amount of output required by a driver obtained from an accelerator pedal, e.g., based on the amount of electrical energy required by the load 14, and transmits the measured target current value data to the gas supply control unit 20.

Then, the gas supply control unit 20 compares the target current value data transmitted from the target electrical energy amount measurement unit 24 and the output current value data transmitted from the actual electrical energy amount measurement unit 22, e.g., the estimated output current value of the fuel cell stack 10, and determines the amount of reactant gases to be supplied based on the larger of the two values.

Subsequently, when the gas supply amount control unit 18 is controlled to supply the amount of reactant gases, determined by the gas supply control unit 20, to the fuel cell stack 10, the determined amount of reactant gases may be supplied from the gas supply unit 12 to the inlet of the fuel cell stack 10.

As a result, it is possible to determine the amount of reactant gases supplied to the fuel cell stack by estimating the output current value of the fuel cell stack based on the current value of the inverter and the amount of current consumed by the BOP components as well as the voltage of the electricity storage device, without the need to directly measure the output current of the fuel cell stack using a separate current sensor.

Thus, advantageously, it is possible to determine the amount of reactant gases supplied to the fuel cell stack by estimating the output current value of the fuel cell stack based on the SOC of the electricity storage device or by estimating the output current value of the fuel cell stack based on the current value of the inverter and the amount of current consumed by the BOP components as well as the voltage of the electricity storage device, without the need to directly measure the output current of the fuel cell stack using a separate current sensor.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method for determining an amount of reactant gases to be supplied to a fuel cell system, the method comprising:
estimating, by a first unit, an output current value of a fuel cell stack by detecting a state of charge of an electricity storage device connected in parallel to the fuel cell stack;
measuring, by a second unit, a target current value according to the amount of output required by a driver;
determining, by a third unit, the amount of reactant gases to be supplied by comparing the estimated output current value and the target current value; and
supplying, by the third unit, the determined amount of reactant gases to the fuel cell stack.

2. The method of claim 1, wherein the estimation of the output current value of the fuel cell stack comprises:
measuring the current voltage of the electricity storage device; and
estimating the output current value of the fuel cell stack by substituting the measured voltage value into a fuel cell voltage-current map.

3. The method of claim 1, wherein the estimation of the output current value of the fuel cell stack comprises:
measuring the current voltage of the electricity storage device; and
estimating the output current value of the fuel cell stack by correcting the measured voltage of the electricity storage device and substituting the corrected voltage into I-V curve data.

4. The method of claim 1, wherein the estimation of the output current value of the fuel cell stack comprises subtracting the current value of the electricity storage device and the amount of current consumed by balance of plant components from a current value of an inverter for motor drive.

5. The method of claim 4, wherein the amount of current consumed by the balance of plant components is calculated using a map.

6. A system configured to determine an amount of reactant gases to be supplied to a fuel cell system, the system comprising:
an first unit configured to estimate an output current value of a fuel cell stack by detecting a state of charge of an electricity storage device connected in parallel to the fuel cell stack;
a second unit configured to charge a target current value according to the amount of output required by a driver;
a third unit configured to determine the amount of reactant gases to be supplied by comparing the estimated output current value and the target current value and supply the determined amount of reactant gases to the fuel cell stack.

7. The system of claim 6, wherein the first unit is further configured to
measure the current voltage of the electricity storage device; and
estimate the output current value of the fuel cell stack by correcting the measured voltage of the electricity storage device and substituting the corrected voltage into I-V curve data.

8. The system of claim 6, wherein the first unit is further configured to subtract the current value of the electricity storage device and the amount of current consumed by balance of plant components from a current value of an inverter for motor drive.

9. The system of claim 8, wherein the amount of current consumed by the balance of plant components is calculated using a map.
